(19) United States
(12) Patent Application Publication
(10) Pub. No.: US 2026/0157372 A1
(43) Pub. Date: Jun. 11, 2026

(54) PESTICIDAL COMPOSITIONS AND METHODS

(71) Applicant: CORTEVA AGRISCIENCE LLC, INDIANAPOLIS, IN (US)

(72) Inventors: RICARDO ACOSTA AMADO, CARMEL, IN (US); JOSEPH C. HERCAMP, NEW PALESTINE, IN (US)

(73) Assignee: CORTEVA AGRISCIENCE LLC, INDIANAPOLIS, IN (US)

(21) Appl. No.: 18/650,262

(22) PCT Filed: Nov. 1, 2022
(86) PCT No.: PCT/US2022/079092

§ 371 Date: Apr. 30, 2024

Related U.S. Application Data
(60) Provisional application No. 63/274,582, filed on Nov. 2, 2021.

(51) Int. Cl. A01N 47/06; A01N 25/32; A01N 37/40; A01P 13/02

(52) U.S. Cl. CPC A01N 47/06; A01N 25/32; A01N 37/40; A01P 13/02

(57) ABSTRACT

Included herein are pesticidal compositions and methods. Some compositions may include a hydroxyphenyl pyruvate dioxygenase (HPPD) inhibitor and a solvent, wherein the HPPD inhibitor is dissolved in the solvent.

### CROSS-REFERENCE TO RELATED APPLICATIONS

This application claims priority to U.S. Provisional Application Ser. No. 63/274,582, filed on Nov. 2, 2022, the entire disclosure of which is hereby expressly incorporated by reference.

### FIELD

This disclosure relates pesticidal compounds and methods related thereto. The present disclosure includes herbicidal compounds, compositions containing the same, and methods of controlling undesirable vegetation with such compounds and compositions.

### BACKGROUND

The occurrence of undesirable vegetation, e.g., weeds, is a constant problem facing farmers in crops, pasture, and other settings. Weeds compete with crops and negatively impact crop yield. The use of chemical herbicides is an important tool in controlling undesirable vegetation.

Thus, there remains a need for new chemical herbicides and herbicidal compositions that offer a broader spectrum of weed control, selectivity, minimal crop damage, storage stability, ease of handling, higher activity against weeds, and/or a means to address herbicide-tolerance developed with respect to conventional herbicides.

### SUMMARY

Disclosed herein are various compositions that may include a hydroxyphenyl pyruvate dioxygenase (HPPD) inhibitor, and a solvent, wherein the HPPD inhibitor is dissolved in the solvent. In various aspects, the HPPD inhibitor may be tolpyralate or an agriculturally acceptable salt or ester thereof. The composition may be an emulsion concentrate, a micro-emulsion, or a suspo-emulsion.

In some aspects, the compositions may include a safener or mixtures of safeners, such as cloquintocet, mefenpyr, or mixtures thereof.

In some aspects, the safener may be from a select class of safeners, such as azole safeners. Thus, some aspects include azole safeners such as fenchlorazole, flurazole, furilazole, isoxadifen, mefenpyr, an agriculturally acceptable salt or ester thereof, or mixtures thereof. For Example, in some aspects, when the safener is mefenpyr, the safener may be provided as an agriculturally acceptable salt or ester, such as mefenpyr-diethyl.

In some aspects, the safener may be benoxacor, diamuron, cumyluron, dimepiperate, dymron, cloquintocet, cyprosulfamide, cyometrinil, dichlormid, fenclorim, fluxofenim, MG 191, AD-67, napthalic anhydride, oxabetrinil, dietholate, metcamifen, or mixtures thereof. For example, in some cases when the safener is cloquintocet, the safener may be cloquintocet-mexyl or cloquintocet-acid.

Also, various aspects can include a second herbicide, such as a nitrile herbicide. In various aspects the nitrile herbicide may be bromoxynil or an agriculturally acceptable salt or ester thereof, such as bromoxynil-octanoate, bromoxynil-heptanoate, or mixtures thereof.

Solvents of various aspects disclosed herein may include solvents such as polar solvents, aprotic solvents, aromatic solvents, carboxylic esters, polar aprotic solvents, aromatic alcohols, aromatic esters, aromatic ketones, cyclic carboxylic esters, alkyl carbonate, lactones, lactates, ketones, esters, alcohols, or mixtures thereof. The amount of solvent may depend on the various aspects disclosed herein and may include compositions where the solvent is from about 10% by weight (w/w) to about 98% by weight (w/w) of the total composition. For example, aspects may include compositions where the composition includes a solvent from amounts of at least about 10% by weight (w/w), about 20% by weight (w/w), about 30% by weight (w/w), about 40% by weight (w/w), or about 50% by weight (w/w), or as great as about 98% by weight (w/w), about 80% by weight (w/w), about 70% by weight (w/w), about 60 by weight (w/w), or about 50% by weight (w/w), or within any range defined between any pair of the foregoing values, such as about 20% by weight (w/w) to about 98% by weight (w/w), about 30% by weight (w/w) to about 80% by weight (w/w), about 40% by weight (w/w) to about 60% by weight (w/w), or about 50% by weight (w/w) to about 60% by weight (w/w).

Some of the aforementioned solvents of various aspect may include benzyl alcohol, propylene glycol mono methyl ether acetate, benzyl acetate, acetophenone, y-butyrolactone, propylene carbonate, dibasic esters, dimethyl sulfoxide, or mixtures thereof. For example, various aspects may include propylene glycol diacetate, dimethyl succinate, dimethyl adipate, dimethyl glutarate, 4-formylmorpholine, N—N-dimethyl lactamide, isosorbide dimethyl ether, ethyl lactate, methoxy propanol, or mixtures thereof.

Further examples of solvents for various aspects can include tetrahydrofurfuryl alcohol, dipropylene glycol mono methyl ether, methyl salicylate, a high-boiling dipolar aprotic solvent, tri-ethyl citrate, or mixtures thereof.

In some aspects that include the nitrile herbicide, sometimes the nitrile herbicide may be dissolved in a second solvent.

### BRIEF DESCRIPTION OF THE DRAWINGS

The above mentioned and other features and objects of this disclosure, and the manner of attaining them, will become more apparent and the disclosure itself will be better understood by reference to the following description of exemplary aspects of the disclosure taken in conjunction with the accompanying drawings, wherein:

FIG. 1 is a table containing the average number of particles below 150 μm for various tolpyralate compositions;

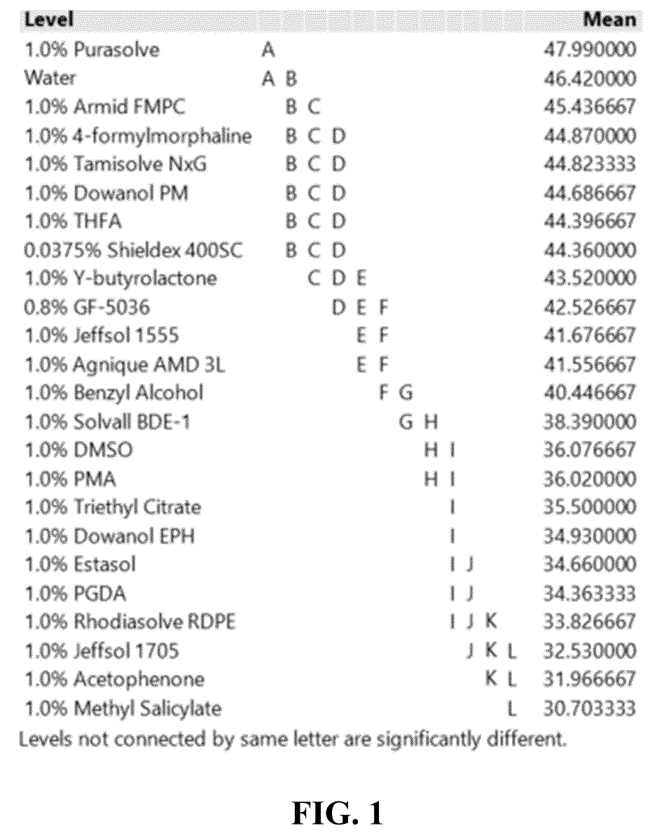

FIG. 2 illustrates the surface tension across surface age for various tolpyralate compositions; and

FIG. 3 is a table with herbicidal data showing the herbicidal response after varying periods for various herbicidal compositions at various use rates.

### DETAILED DESCRIPTION

### I. Definitions

Terms used herein will have their customary meaning in the art unless specified otherwise. The singular forms “a,” and “the” include plural references unless stated otherwise. To the extent that the term “or” is employed (e.g., A or B) it is intended to mean “A or B or both.” If this disclosure intends to indicate “only A or B but not both” then the term “only A or B but not both” will be employed. Thus, use of the term “or” herein is the inclusive and not the exclusive use.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

As used herein, the terms “herbicide” and “herbicidal active ingredient” may be understood to include an active ingredient that kills, controls, or otherwise adversely modifies the growth of vegetation, particularly undesirable vegetation such as weed species, when applied in an appropriate amount.

As used herein, the term “herbicidal effect” may be understood to include an adversely modifying effect of an active ingredient on vegetation, including, for example, a deviation from natural growth or development, killing, regulation, desiccation, growth inhibition, growth reduction, and retardation. The term “herbicidal activity” refers generally to herbicidal effects of an active ingredient.

As used herein, “applying” an herbicide or herbicidal composition refers to delivering it directly to the targeted vegetation or to the locus thereof or to the area where control of undesirable vegetation is desired. Methods of application include, but are not limited to, pre-emergently contacting soil or water, post-emergently contacting the undesirable vegetation, or contacting the area adjacent to the undesirable vegetation.

As used herein, the term “vegetation” can include, for instance, dormant seeds, germinating seeds, emerging seedlings, plants propagating from vegetative propagules, immature vegetation, and established vegetation.

As used herein, the term “crop” refers to desired vegetation, for instance, plants that are grown to provide food, shelter, pasture, erosion control, etc. Example crops include cereals, legumes, vegetables, turf, grasslands, orchard and timber trees, grapevines, etc. Preferably, herbicides or herbicidal compositions have zero or minimal herbicidal effect on crops.

As used herein, the term “undesirable vegetation” refers to vegetation that is not wanted in a given area, for instance, weed species. Herbicides or herbicidal compositions are used to control undesirable vegetation. Preferably, herbicides or herbicidal compositions have a large or complete herbicidal effect on undesirable vegetation.

As used herein, “active ingredient” or “ai” may be understood to include a chemical compound or composition that has an effect on vegetation; specifically, a herbicidal effect or a safening effect on the vegetation.

As used herein, “acid equivalent” or “ae” may be understood to include the amount of the acid form of an active ingredient that is calculated from the amount of a salt or ester form of that active ingredient. For example, if the acid form of an active ingredient “Z” has a molecular weight of 100 Dalton, and the salt form of Z has a molecular weight of 130 Dalton, an application of 130 g ai/ha of the Z salt would be equal to applying 100 g ae/ha of the acid form of Z:

$$130 g ai / ja Z salt * ( 100 Da Z acid / 130 Da Z salt ) = 100 g ae / ha Z acid .$$

### II. Safeners

In addition to the various HPPD herbicides dissolved in a solvent, the compositions and methods of the present disclosure can include safeners. Herbicide safeners are molecules used in combination with herbicides to make them “safer”—that is, to reduce the herbicidal effect of the herbicide on crop plants and to improve selectivity between crops and the undesirable vegetation being targeted by the herbicide. Herbicide safeners can be used to pre-treat crop seeds prior to planting. Herbicide safeners may also be sprayed on plants as a mixture with the herbicide, or separately and sequentially with the herbicide.

As described previously, some aspects may include a safener or mixtures of safeners, such as cloquintocet, mefenpyr, or mixtures thereof. For example, in some cases when the safener is cloquintocet, the safener may be cloquintocet-mexyl, cloquintocet-acid, or mixtures thereof. Similarly, in some aspects, when the safener is mefenpyr, the safener may be mefenpyr-diethyl.

Quinolinoxyacetate safeners are known in the art and described, for example, in U.S. Pat. No. 4,902,340 and U.S. Patent Application Publication No. 2014/0031224, the disclosures of which are both incorporated by reference herein. Quinolinoxyacetate safeners include, for example, cloquintocet and the derivatives thereof. Cloquintocet is a quinoline compound having the following chemical structure:

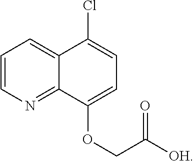 [SMILES: O=C(O)COc1ccc(Cl)c2cccnc12]

This form of cloquintocet may also be referred to as “cloquintocet-acid.”

In some aspects, the safener can comprise an agriculturally acceptable salt of cloquintocet. Agriculturally acceptable salts of cloquintocet include, for example sodium, potassium, ammonium, monoethanolammonium, diethanolammonium, triethanolammonium, monoisopropanolammonium, diisopropanolammonium, triisopropanolammonium, choline, N,N-dimethylethanolammonium, diethylammonium, dimethylammonium, trimethylammonium, triethylammonium, and isopropylammonium salts of cloquintocet.

In some aspects, the safener can comprise an agriculturally acceptable ester of cloquintocet. Agriculturally acceptable esters of cloquintocet include, for example, the methyl, ethyl, propyl, butyl, or methylhexyl (also known as mexyl) ester of cloquintocet. In some aspects, the safener comprises cloquintocet-mexyl, the structure of which is shown below.

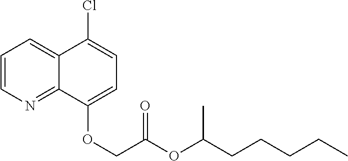 [SMILES: CCCCCC(C)OC(=O)COc1ccc(Cl)c2cccnc12]

In some aspects, the safener can comprise cloquintocet-acid, an agriculturally acceptable salt of cloquintocet, an agriculturally acceptable ester of cloquintocet, or mixtures thereof. Cloquintocet can be a safener when applied in combination with herbicides and can be used to reduce phytotoxicity to crops such as wheat, barley, triticale, rye, teff, oats, maize, sorghum, rice, millet, canola/oilseed rape, sunflower, sugar beet, cotton, sugarcane, and pasture grasses. In some aspects, the undesirable vegetation is in broadleaf crops. In some aspects, the undesirable vegetation is in canola, flax, sunflower, soy, or cotton.

Cloquintocet or an agriculturally acceptable salt or ester thereof can be used in an amount sufficient to induce a safening effect. In some aspects, cloquintocet or an agriculturally acceptable salt or ester thereof is applied to vegetation or an area adjacent the vegetation or applied to soil or water in an amount of 1 g active ingredient per hectare (ai/ha) or greater, such as 2 g ai/ha or greater, 3 g ai/ha or greater, 4 g ai/ha or greater, 5 g ai/ha or greater, 6 g ai/ha or greater, 7 g ai/ha or greater, 8 g ai/ha or greater, 9 g ai/ha or greater, 10 g ai/ha or greater, 11 g ai/ha or greater, 12 g ai/ha or greater, 13 g ai/ha or greater, 14 g ai/ha or greater, 15 g ai/ha or greater, 16 g ai/ha or greater, 17 g ai/ha or greater, 18 g ai/ha or greater, 19 g ai/ha or greater, 20 g ai/ha or greater, 22 g ai/ha or greater, 24 g ai/ha or greater, 25 g ai/ha or greater, 26 g ai/ha or greater, 28 g ai/ha or greater, 30 g ai/ha or greater, 32 g ai/ha or greater, 34 g ai/ha or greater, 35 g ai/ha or greater, 36 g ai/ha or greater, 38 g ai/ha or greater, 40 g ai/ha or greater, 42.5 g ai/ha or greater, 45 g ai/ha or greater, 47.5 g ai/ha or greater, 50 g ai/ha or greater, 52.5 g ai/ha or greater, 55 g ai/ha or greater, 57.5 g ai/ha or greater, 60 g ai/ha or greater, 65 g ai/ha or greater, 70 g ai/ha or greater, 75 g ai/ha or greater, 80 g ai/ha or greater, 85 g ai/ha or greater, 90 g ai/ha or greater, 95 g ai/ha or greater, 100 g ai/ha or greater, 110 g ai/ha or greater, 120 g ai/ha or greater, 130 g ai/ha or greater, 140 g ai/ha or greater, 150 g ai/ha or greater, 160 g ai/ha or greater, 170 g ai/ha or greater, 180 g ai/ha or greater, 190 g ai/ha or greater, 200 g ai/ha or greater, 210 g ai/ha or greater, 220 g ai/ha or greater, 230 g ai/ha or greater, 240 g ai/ha or greater, 250 g ai/ha or greater, 260 g ai/ha or greater, 270 g ai/ha or greater, 280 g ai/ha or greater, or 290 g ai/ha or greater; in an amount of 300 g ai/ha or less such as 290 g ai/ha or less, 280 g ai/ha or less, 270 g ai/ha or less, 260 g a/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 57.5 g ai/ha or less, 55 g ai/ha or less, 52.5 g ai/ha or less, 50 g ai/ha or less, 47.5 g ai/ha or less, 45 g ai/ha or less, 42.5 g ai/ha or less, 40 g ai/ha or less, 38 g ai/ha or less, 36 g ai/ha or less, 35 g ai/ha or less, 34 g ai/ha or less, 32 g ai/ha or less, 30 g ai/ha or less, 28 g ai/ha or less, 26 g ai/ha or less, 25 g ai/ha or less, 24 g ai/ha or less, 22 g ai/ha or less, 20 g ai/ha or less, 19 g ai/ha or less, 18 g ai/ha or less, 17 g ai/ha or less, 16 g ai/ha or less, 15 g ai/ha or less, 14 g ai/ha or less, 13 g ai/ha or less, 12 g ai/ha or less, 11 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3 g ai/ha or less, or 2 g ai/ha or less; or in an amount within any range defined between any pair of the preceding values, such as from 1 g ai/ha to 300 g ai/ha, from 5 g ai/ha to 150 g ai/ha, from 10 g ai/ha to 200 g ai/ha, from 20 g ai/ha to 75 g ai/ha, from 40 g ai/ha to 100 g ai/ha, 1 g ai/ha to 10 g ai/ha, 2 g ai/ha to 8 g ai/ha, or 3 g ai/ha to 4 g ai/ha.

A safened composition comprising (a) a hydroxyphenyl pyruvate dioxygenase (HPPD) inhibitor dissolved in a solvent may be mixed with or applied in combination with (b) a safener comprising cloquintocet or an agriculturally acceptable salt or ester thereof.

In some aspects, (a) and (b) are used in an amount sufficient to induce an unexpectedly enhanced herbicidal effect (e.g., increased damage or injury to undesirable vegetation) while still showing good crop compatibility (e.g., no increased damage to crops or minimal increased damage or injury to crops) when compared to the individual application of the herbicidal compounds (a) or (b). In some aspects, the damage or injury to undesirable vegetation caused by the safened compositions and methods disclosed herein is evaluated using a scale from 0% to 100%, when compared with the untreated control vegetation, wherein 0% indicates no damage to the undesirable vegetation and 100% indicates complete destruction of the undesirable vegetation. Similarly, in some aspects, the damage or injury to the crop caused by the safened compositions and methods disclosed herein is evaluated using a scale from 0% to 100%, when compared with control crops treated with only the herbicide or the safener, wherein 0% indicates no damage to the crop and 100% indicates complete destruction of the crop.

In some aspects, the joint action of (a) a hydroxyphenyl pyruvate dioxygenase (HPPD) inhibitor dissolved in a solvent and (b) the cloquintocet safener or an agriculturally acceptable salt or ester thereof results in unexpectedly enhanced herbicidal effect against undesirable vegetation, even at application rates below those typically used for the herbicide to have a herbicidal effect on its own. In some aspects, the compositions and methods disclosed herein can, based on the individual components, be used at lower application rates to achieve a herbicidal effect comparable to the effect produced by the individual components at normal application rates. In some aspects, the joint action of (a) a hydroxyphenyl pyruvate dioxygenase (HPPD) inhibitor dissolved in a solvent and (b) the cloquintocet safener or an agriculturally acceptable salt or ester thereof results in an unexpected protective effect for desired crops against damage to the crops that might be caused by the herbicide alone.

In some aspects, the weight ratio of (a) a hydroxyphenyl pyruvate dioxygenase (HPPD) inhibitor dissolved in a solvent (in g ae/ha) to (b) the cloquintocet safener or an agriculturally acceptable salt or ester thereof (in g ai/ha) can be 1:5 or more, such as 1:4.75 or more, 1:4.5 or more, 1:4.25 or more, 1:4 or more, 1:3.75 or more, 1:3.5 or more, 1:3.25 or more, 1:3 or more, 1:2.75 or more, 1:2.5 or more, 1:2.25 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.2:1 or more, 1.3:1 or more, 1.4:1 or more, 1.5:1 or more, 1.6:1 or more, 1.7:1 or more, 1.8:1 or more, 1.9:1 or more, 2:1 or more, 2.25:1 or more, 2.5:1 or more, 2.75:1 or more, 3:1 or more, 3.25:1 or more, 3.5:1 or more, 3.75:1 or more, 4:1 or more, 4.25:1 or more, 4.5:1 or more, 4.75:1 or more, 5:1 or more, 6:1 or more, 7:1 or more, 8:1 or more, 9:1 or more, 10:1 or more, 11:1 or more, 12:1 or more, 13:1 or more, 14:1 or more, 15:1 or more, 16:1 or more, 17:1 or more, 18:1 or more, 19:1 or more, 20:1 or more, 25:1 or more, 30:1 or more, 35:1 or more, 40:1 or more, 45:1 or more, 50:1 or more, 55:1 or more, or 60:1 or more; the weight ratio of (a) to (b) can be 65:1 or less, such as 60:1 or less, 55:1 or less, 50:1 or less, 45:1 or less, 40:1 or less, 35:1 or less, 30:1 or less, 25:1 or less, 20:1 or less, 19:1 or less, 18:1 or less, 17:1 or less, 16:1 or less, 15:1 or less, 14:1 or less, 13:1 or less, 12:1 or less, 11:1 or less, 10:1 or less, 9:1 or less, 8:1 or less, 7:1 or less, 6:1 or less, 5:1 or less, 4.75:1 or less, 4.5:1 or less, 4.25:1 or less, 4:1 or less, 3.75:1 or less, 3.5:1 or less, 3.25:1 or less, 3:1 or less, 2.75:1 or less, 2.5:1 or less, 2.25:1 or less, 2:1 or less, 1.9:1 or less, 1.8:1 or less, 1.7:1 or less, 1.6:1 or less, 1.5:1 or less, 1.4:1 or less, 1.3:1 or less, 1.2:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:2.25 or less, 1:2.5 or less, 1:2.75 or less, 1:3 or less, 1:3.25 or less, 1:3.5 or less, 1:3.75 or less, 1:4 or less, 1:4.25 or less, 1:4.5 or less, or 1:4.75 or less; or the weight ratio of (a) to (b) can range from any of the minimum ratios to any of the maximum ratios provided above, such as from 1:5 to 65:1, from 1:2 to 25:1, from 1:1 to 15:1, from 1:3 to 4:1, or from 1:1.5 to 10:1.

In some aspects, (a) and (b), independently, can be employed in a purity of from 90% to 100% (e.g., from 95% to 100%) according to nuclear magnetic resonance (NMR) spectroscopy.

In some aspects, the safener may be an azole carboxylate safener or an agriculturally acceptable salt or ester thereof. For example, as previously described with the safener mefenpyr. Azoles are a class of five-membered nitrogen heterocyclic ring compounds containing at least one additional heteroatom (e.g., nitrogen, sulfur, or oxygen) within the heterocyclic ring. Examples of azoles include, for example, pyrazoles, imidazoles, thiazoles, oxazoles, isoxazoles and triazoles.

Azole carboxylate safeners are a class of safeners based on carboxylate-substituted azole moieties. Examples of azole carboxylate safeners include pyrazole carboxylate safeners, imidazole carboxylate safeners, thiazole carboxylate safeners, oxazole carboxylate safeners, isoxazole carboxylate safeners, and triazole carboxylate safeners. In some aspects, the composition can include an azole carboxylate safener selected from the group consisting of fenchlorazole, flurazole, furilazole, isoxadifen, mefenpyr, agriculturally acceptable salts or esters thereof, or combinations thereof. In some aspects, the azole carboxylate safener can include fenchlorazole-ethyl, isoxadifen-ethyl, mefenpyr-diethyl, or combinations thereof.

In some aspects, the azole carboxylate safener can comprise fenchlorazole, shown below, or an agriculturally acceptable salt or ester thereof. Fenchlorazole's safening activity is described in The Pesticide Manual, Eighteenth Edition, 2016.

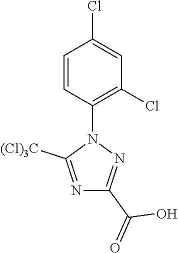

In some aspects, the fenchlorazole is provided as an agriculturally acceptable salt or ester. An exemplary agriculturally acceptable ester of fenchlorazole is fenchlorazole-ethyl, shown below.

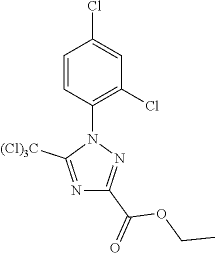

In some aspects, the azole carboxylate safener can comprise flurazole, shown below, or an agriculturally acceptable salt or ester thereof. Flurazole's safening activity is described in The Pesticide Manual, Eighteenth Edition, 2016.

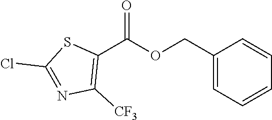 [SMILES: O=C(OCc1ccccc1)c1sc(Cl)nc1C(F)(F)F]

In some aspects, the azole carboxylate safener can comprise furilazole, shown below, or an agriculturally acceptable salt or ester thereof. Furilazole's safening activity is described in The Pesticide Manual, Eighteenth Edition, 2016.

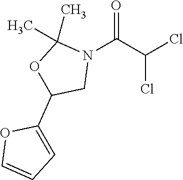 [SMILES: CC1(C)OC(c2ccco2)CN1C(=O)C(Cl)Cl]

In some aspects, the azole carboxylate safener can comprise isoxadifen, shown below, or an agriculturally acceptable salt or ester thereof. Isoxadifen's safening activity is described in The Pesticide Manual, Eighteenth Edition, 2016.

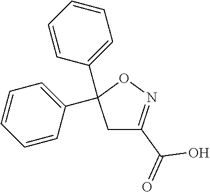 [SMILES: O=C(O)C1=NOC(c2ccccc2)(c2ccccc2)C1]

In some aspects, the isoxadifen is provided as an agriculturally acceptable salt or ester. An exemplary agriculturally acceptable ester of isoxadifen is isoxadifen-ethyl, shown below.

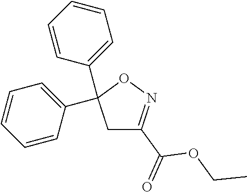 [SMILES: CCOC(=O)C1=NOC(c2ccccc2)(c2ccccc2)C1]

In some aspects, the azole carboxylate safener can comprise mefenpyr, shown below, or an agriculturally acceptable salt or ester thereof. Mefenpyr's safening activity is described in The Pesticide Manual, Eighteenth Edition, 2016.

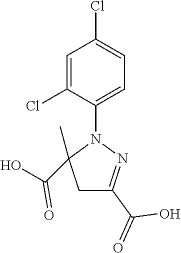 [SMILES: CC1(C(=O)O)CC(C(=O)O)=NN1c1ccc(Cl)cc1Cl]

In some aspects, the mefenpyr is provided as an agriculturally acceptable salt or ester. An exemplary agriculturally acceptable ester of mefenpyr is mefenpyr-diethyl, shown below.

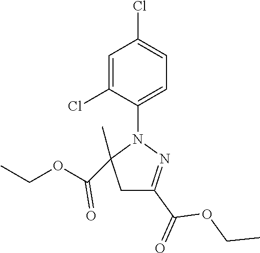 [SMILES: CCOC(=O)C1=NN(c2ccc(Cl)cc2Cl)C(C)(C(=O)OCC)C1]

In some aspects, the azole carboxylate safener can be provided as an agriculturally acceptable ester. Suitable esters include, but are not limited to, methyl, ethyl, isopropyl, butyl, hexyl, heptyl, isoheptyl, mexyl, isooctyl, 2-ethylhexyl and butoxyethyl esters, and aryl esters such as benzyl. Exemplary agriculturally acceptable esters of the azole carboxylate safeners described herein include methyl, ethyl, and diethyl esters.

In some aspects, the azole carboxylate safener can comprise an agriculturally acceptable salt of the azole carboxylate safener. Agriculturally acceptable salts of the azole carboxylate safener include, for example sodium, potassium, ammonium, monoethanolammonium, diethanolammonium, triethanolammonium, monoisopropanolammonium, diisopropanolammonium, triisopropanolammonium, choline, N,N-dimethylethanolammonium, diethylammonium, dimethylammonium, trimethylammonium, triethylammonium, and isopropylammonium salts of the azole carboxylate safener.

An azole carboxylate safener, when applied in combination with herbicides, can be used to reduce phytotoxicity to crops such as wheat, barley, triticale, rye, teff, oats, maize, sorghum, millet, rice, millet, canola/oilseed rape, flax, soy, sunflower, sugar beet, cotton, sugarcane, and pasture grasses.

The azole carboxylate safener or an agriculturally acceptable salt or ester thereof can be used in an amount sufficient to induce a safening effect. In some aspects, the azole carboxylate safener is selected from the group consisting of fenchlorazole, fenclorim, flurazole, furilazole, isoxadifen, mefenpyr, an agriculturally acceptable salt or ester thereof, or combinations thereof, and is applied to vegetation or an area adjacent the vegetation or applied to soil or water in an amount of 1 g active ingredient per hectare (ai/ha) or greater, such as 2 g ai/ha or greater, 3 g ai/ha or greater, 4 g ai/ha or greater, 5 g ai/ha or greater, 6 g ai/ha or greater, 7 g ai/ha or greater, 8 g ai/ha or greater, 9 g ai/ha or greater, 10 g ai/ha or greater, 11 g ai/ha or greater, 12 g ai/ha or greater, 13 g ai/ha or greater, 14 g ai/ha or greater, 15 g ai/ha or greater, 16 g ai/ha or greater, 17 g ai/ha or greater, 18 g ai/ha or greater, 19 g ai/ha or greater, 20 g ai/ha or greater, 22 g ai/ha or greater, 24 g ai/ha or greater, 25 g ai/ha or greater, 26 g ai/ha or greater, 28 g ai/ha or greater, 30 g ai/ha or greater, 32 g ai/ha or greater, 34 g ai/ha or greater, 35 g ai/ha or greater, 36 g ai/ha or greater, 38 g ai/ha or greater, 40 g ai/ha or greater, 42.5 g ai/ha or greater, 45 g ai/ha or greater, 47.5 g ai/ha or greater, 50 g ai/ha or greater, 52.5 g ai/ha or greater, 55 g ai/ha or greater, 57.5 g ai/ha or greater, 60 g ai/ha or greater, 65 g ai/ha or greater, 70 g ai/ha or greater, 75 g ai/ha or greater, 80 g ai/ha or greater, 85 g ai/ha or greater, 90 g ai/ha or greater, 95 g ai/ha or greater, 100 g ai/ha or greater, 110 g ai/ha or greater, 120 g ai/ha or greater, 130 g ai/ha or greater, 140 g ai/ha or greater, 150 g ai/ha or greater, 160 g ai/ha or greater, 170 g ai/ha or greater, 180 g ai/ha or greater, 190 g ai/ha or greater, 200 g ai/ha or greater, 210 g ai/ha or greater, 220 g ai/ha or greater, 230 g ai/ha or greater, 240 g ai/ha or greater, 250 g ai/ha or greater, 260 g ai/ha or greater, 270 g ai/ha or greater, 280 g ai/ha or greater, or 290 g ai/ha or greater; in an amount of 300 g ai/ha or less, such as 290 g ai/ha or less, 280 g ai/ha or less, 270 g ai/ha or less, 260 g a/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 57.5 g ai/ha or less, 55 g ai/ha or less, 52.5 g ai/ha or less, 50 g ai/ha or less, 47.5 g ai/ha or less, 45 g ai/ha or less, 42.5 g ai/ha or less, 40 g ai/ha or less, 38 g ai/ha or less, 36 g ai/ha or less, 35 g ai/ha or less, 34 g ai/ha or less, 32 g ai/ha or less, 30 g ai/ha or less, 28 g ai/ha or less, 26 g ai/ha or less, 25 g ai/ha or less, 24 g ai/ha or less, 22 g ai/ha or less, 20 g ai/ha or less, 19 g ai/ha or less, 18 g ai/ha or less, 17 g ai/ha or less, 16 g ai/ha or less, 15 g ai/ha or less, 14 g ai/ha or less, 13 g ai/ha or less, 12 g ai/ha or less, 11 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3 g ai/ha or less, or 2 g ai/ha or less; or in an amount within any range defined between any pair of the preceding values, such as from 1 g ai/ha to 300 g ai/ha, from 5 g ai/ha to 150 g ai/ha, from 10 g ai/ha to 200 g ai/ha, from 20 g ai/ha to 75 g ai/ha, or from 40 g ai/ha to 100 g ai/ha.

### Safened Compositions

A safened composition comprising (a) a hydroxyphenyl pyruvate dioxygenase (HPPD) inhibitor dissolved in a solvent may be mixed with or applied in combination with (b) a safener, such as, an azole carboxylate safener or an agriculturally acceptable salt or ester thereof.

In some aspects, (a) and (b) are used in an amount sufficient to induce an unexpectedly enhanced herbicidal effect (e.g., increased damage or injury to undesirable vegetation) while still showing good crop compatibility (e.g., no increased damage to crops or minimal increased damage or injury to crops) when compared to the individual application of the herbicidal compounds (a) or (b). In some aspects, the damage or injury to undesirable vegetation caused by the safened compositions and methods disclosed herein is evaluated using a scale from 0% to 100%, when compared with the untreated control vegetation, wherein 0% indicates no damage to the undesirable vegetation and 100% indicates complete destruction of the undesirable vegetation. Similarly, in some aspects, the damage or injury to the crop caused by the safened compositions and methods disclosed herein is evaluated using a scale from 0% to 100%, when compared with control crops treated with only the herbicide or the safener, wherein 0% indicates no damage to the crop and 100% indicates complete destruction of the crop.

In some aspects, the joint action of (a) a hydroxyphenyl pyruvate dioxygenase (HPPD) inhibitor dissolved in a solvent and (b) the azole carboxylate safener or an agriculturally acceptable salt or ester thereof results in unexpectedly enhanced herbicidal effect against undesirable vegetation, even at application rates below those typically used for the herbicide to have a herbicidal effect on its own. In some aspects, the compositions and methods disclosed herein can, based on the individual components, be used at lower application rates to achieve a herbicidal effect comparable to the effect produced by the individual components at normal application rates. In some aspects, the joint action of (a) a hydroxyphenyl pyruvate dioxygenase (HPPD) inhibitor dissolved in a solvent and (b) the azole carboxylate safener or an agriculturally acceptable salt or ester thereof results in an unexpected protective effect for desired crops against damage to the crops that might be caused by the herbicide alone.

In some aspects, the weight ratio of (a) a hydroxyphenyl pyruvate dioxygenase (HPPD) inhibitor dissolved in a solvent (in g ae/ha) to (b) the safener, such as cloquintocet (such as cloquintocet-mexyl or cloquintocet-acid), mefenpyr (such as mefenpyr-diethyl), or an azole carboxylate safener or an agriculturally acceptable salt or ester thereof (in g ai/ha) can be 1:5 or more, such as 1:4.75 or more, 1:4.5 or more, 1:4.25 or more, 1:4 or more, 1:3.75 or more, 1:3.5 or more, 1:3.25 or more, 1:3 or more, 1:2.75 or more, 1:2.5 or more, 1:2.25 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.2:1 or more, 1.3:1 or more, 1.4:1 or more, 1.5:1 or more, 1.6:1 or more, 1.7:1 or more, 1.8:1 or more, 1.9:1 or more, 2:1 or more, 2.25:1 or more, 2.5:1 or more, 2.75:1 or more, 3:1 or more, 3.25:1 or more, 3.5:1 or more, 3.75:1 or more, 4:1 or more, 4.25:1 or more, 4.5:1 or more, 4.75:1 or more, or 5:1 or more; the weight ratio of (a) to (b) can be 10:1 or less, such as 5:1 or less, 4.75:1 or less, 4.5:1 or less, 4.25:1 or less, 4:1 or less, 3.75:1 or less, 3.5:1 or less, 3.25:1 or less, 3:1 or less, 2.75:1 or less, 2.5:1 or less, 2.25:1 or less, 2:1 or less, 1.9:1 or less, 1.8:1 or less, 1.7:1 or less, 1.6:1 or less, 1.5:1 or less, 1.4:1 or less, 1.3:1 or less, 1.2:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:2.25 or less, 1:2.5 or less, 1:2.75 or less, 1:3 or less, 1:3.25 or less, 1:3.5 or less, 1:3.75 or less, 1:4 or less, 1:4.25 or less, 1:4.5 or less, or 1:4.75 or less; or the weight ratio of (a) to (b) can range from any of the minimum ratios to any of the maximum ratios provided above, such as from 1:5 to 10:1, from 1:2 to 5:1, from 1:1 to 3:1, from 1:3 to 4:1, or from 1:1.5 to 3.5:1.

In some aspects, (a) and (b), independently, can be employed in a purity of from 90% to 100% (e.g., from 95% to 100%) according to nuclear magnetic resonance (NMR) spectroscopy.

Additionally, compositions including a hydroxyphenyl pyruvate dioxygenase (HPPD) inhibitor dissolved in a solvent may also include another pesticidal active, such as an herbicide. In some aspects, the herbicides may be nitrile herbicides and their agriculturally acceptable salts and esters. Exemplary nitrile herbicides include bromoxynil, ioxynil, or an agriculturally acceptable salt or ester thereof.

The following formulations below help to illustrate various aspects of the pesticidal formulations disclosed herein. Such formulations include an HPPD herbicide dissolved in various test solvents and then the dynamic surface tension for the formulations was tested.

### Example 1-1

The following emulsifiable concentrate formulation was created with 15 g/L of tolpyralate. About 1.55 wt % of tolpyralate tech (97% purity) was dissolved in about 48.45 wt % of benzyl alcohol, about 10 wt % of an adjuvant (such as Lutensol TDS 6), about 10 wt % of a mixture of emulsifiers (such as about 8 wt % of ANIQUE CSO-25, about 1 wt % of ATLAS G5000, and about 1 wt % of Aerosol OT-S), and about 30 wt % solvent naphtha (petroleum), heavy aromatic (such as Aromatic 150 naphthalene depleted).

### Example 1-2

The following emulsifiable concentrate formulation was created with 15 g/L of tolpyralate. About 1.55 wt % of tolpyralate tech (97% purity) was dissolved in about 48.45 wt % of ethylene glycol mono phenyl ether (such as Dowanol EPH), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-3

The following emulsifiable concentrate formulation was created with 15 g/L of tolpyralate. About 1.55 wt % of tolpyralate tech (97% purity) was dissolved in about 48.45 wt % of acetophenone, about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-4

The following emulsifiable concentrate formulation was created with 15 g/L of tolpyralate. About 1.55 wt % of tolpyralate tech (97% purity) was dissolved in about 48.45 wt % of methyl salicylate, about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-5

The following emulsifiable concentrate formulation was created with 15 g/L of tolpyralate. About 1.55 wt % of tolpyralate tech (97% purity) was dissolved in about 48.45 wt % of triethyl citrate, about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-6

The following emulsifiable concentrate formulation was created with 15 g/L of tolpyralate. About 1.55 wt % of tolpyralate tech (97% purity) was dissolved in about 48.45 wt % of propylene glycol mono methyl ether (such as Dowanol PM), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-7

The following emulsifiable concentrate formulation was created with 15 g/L of tolpyralate. About 1.55 wt % of tolpyralate tech (97% purity) was dissolved in about 48.45 wt % of benzyl acetate (such as Jeffsol AG 1705), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-8

The following emulsifiable concentrate formulation was created with 15 g/L of tolpyralate. About 1.55 wt % of tolpyralate tech (97% purity) was dissolved in about 48.45 wt % of tetrahydrofurfuryl alcohol (THFA), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-9

The following emulsifiable concentrate formulation was created with 15 g/L of tolpyralate. About 1.55 wt % of tolpyralate tech (97% purity) was dissolved in about 48.45 wt % of propylene carbonate (such as Jeffsol AG 1555), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-10

The following emulsifiable concentrate formulation was created with 15 g/L of tolpyralate. About 1.55 wt % of tolpyralate tech (97% purity) was dissolved in about 48.45 wt % of dimethyl sulfoxide (DMSO), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-11

The following emulsifiable concentrate formulation was created with 15 g/L of tolpyralate. About 1.55 wt % of tolpyralate tech (97% purity) was dissolved in about 48.45 wt % of a mixture of dimethyl glutarate, dimethyl succinate, and dimethyl adipate (such as Rhodiasolv RPDE), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-12

The following emulsifiable concentrate formulation was created with 15 g/L of tolpyralate. About 1.55 wt % of tolpyralate tech (97% purity) was dissolved in about 48.45 wt % of ethyl lactate (such as Purasolv EL), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-13

The following emulsifiable concentrate formulation was created with 15 g/L of tolpyralate. About 1.55 wt % of tolpyralate tech (97% purity) was dissolved in about 48.45 wt % of a 4-carbon lactone (γ-butyrolactone), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-14

The following emulsifiable concentrate formulation was created with 15 g/L of tolpyralate. About 1.55 wt % of tolpyralate tech (97% purity) was dissolved in about 48.45 wt % of propylene glycol mono methyl ether acetate (such as Dowanol PMA), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-15

The following emulsifiable concentrate formulation was created with 15 g/L of tolpyralate. About 1.55 wt % of tolpyralate tech (97% purity) was dissolved in about 48.45 wt % mixture of dimethyl glutarate, dimethyl succinate, and dimethyl adipate (such as Estasol), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-16

The following emulsifiable concentrate formulation was created with 15 g/L of tolpyralate. About 1.55 wt % of tolpyralate tech (97% purity) was dissolved in about 48.45 wt % of propylene glycol diacetate (such as Dowanol PGDA), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-17

The following emulsifiable concentrate formulation was created with 15 g/L of tolpyralate. About 1.55 wt % of tolpyralate tech (97% purity) was dissolved in about 48.45 wt % of N,N-dimethyl lactamide (such as Agnique AMD 3L), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-18

The following emulsifiable concentrate formulation was created with 15 g/L of tolpyralate. About 1.55 wt % of tolpyralate tech (97% purity) was dissolved in about 48.45 wt % of n-butyl pyrrolidone (such as TamiSolve NxG), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-19

The following emulsifiable concentrate formulation was created with 15 g/L of tolpyralate. About 1.55 wt % of tolpyralate tech (97% purity) was dissolved in about 48.45 wt % mixture of 4-formylmorpholine and propylene carbonate (such as Armid FMPC), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-20

The following emulsifiable concentrate formulation was created with 15 g/L of tolpyralate. About 1.55 wt % of tolpyralate tech (97% purity) was dissolved in about 48.45 wt % of 4-formylmorpholine, about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-21

The following emulsifiable concentrate formulation was created with 15 g/L of tolpyralate. About 1.55 wt % of tolpyralate tech (97% purity) was dissolved in about 48.45 wt % of isosorbide dimethyl ether (such as Solvall BDE-1), about 10 wt % of an adjuvant (such as Lutensol TDS 6), about 30 wt % solvent naphtha (petroleum), heavy aromatic (such as Aromatic 150 naphthalene depleted), and about 10 wt % of a mixture of emulsifiers (such as about 8 wt % of ANIQUE CSO-25, about 1 wt % of ATLAS G5000, and about 1 wt % of Aerosol OT-S).

### Example 1-22

The following emulsifiable concentrate formulation was created with 18.66 g/L of tolpyralate and 186.60 gae/l bromoxynil-octanoate. About 1.78 wt % of tolpyralate tech (97% purity) was dissolved in about 20.87 wt % of benzyl alcohol, mixed with about 10 wt % of an adjuvant (such as Lutensol TDS 6), about 10 wt % of a mixture of emulsifiers (such as about 8 wt % of ANIQUE CSO-25, about 1 wt % of ATLAS G5000, and about 1 wt % of Aerosol OT-S), and about 26.06 wt % of bromoxynil (bromoxynil-octanoate) tech (96.4% purity) dissolved in about 30.84 wt % of a solvent naphtha (petroleum), heavy aromatic (such as Aromatic 150 naphthalene depleted).

Various compositions, such as those described above can have improved and/or desired viscosities for desired uses, such as in agricultural uses.

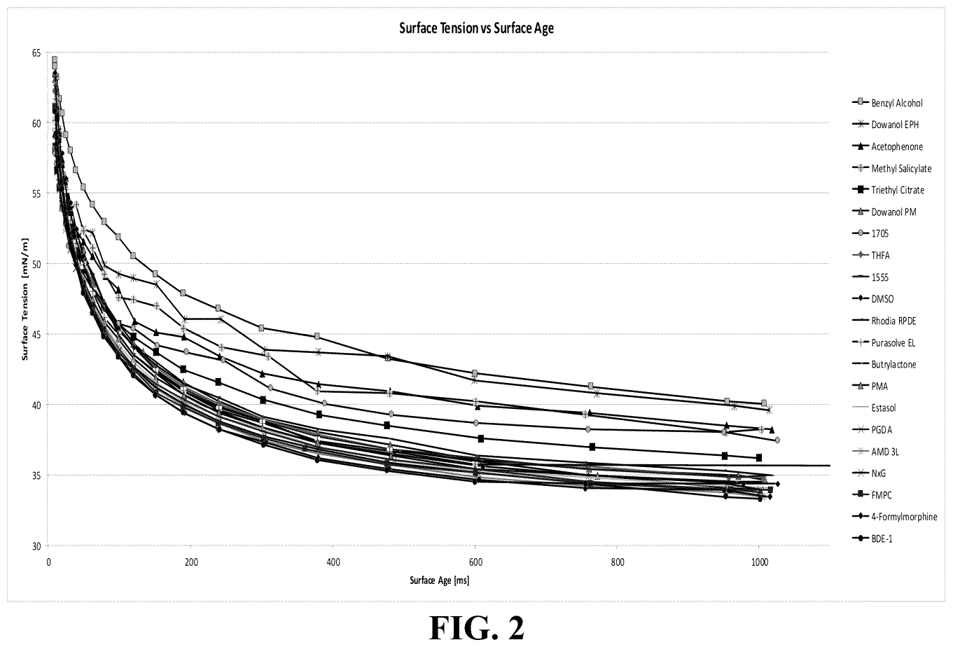

Also, many aspects contained in this disclosure can also have improved spray drift properties. Spray drift can be understood to include the movement of pesticide particles (such as dust or fine droplets) through the air at the time of application or soon after. Sometimes, the movement of particles can move to a site other than the intended area. FIG. 2 illustrates the percentage of spray drift fines having a particle diameter of less than 150 μm (driftables) for dilutions of the examples estimated to deliver 15 grams tolpyralate per hectare of various solvents to further illustrate various statistical differences between solvents with respect to spray drift potential.

Samples were sprayed using a Teejet® XR11002 flat fan nozzle (Teejet Technologies; Wheaton, Ill.) at 40 psi (276 kiloPascal) and the spray droplet size distribution measurement was made with a Sympatec Helos/KF high resolution laser diffraction particle sizer with an R7 lens (Sympatec GmbH; Clausthal-Zellerfeld, Germany). The tip of the nozzle was situated 12 inches (30.5 centimeters) above the path of the laser beam of the Sympatec particle sizer. The percentage of driftable fines was expressed as the volume percentage of spray droplets below 150 m volume mean diameter (VMD).

Various aspects of this disclosure can have improved dynamic surface tension. Without being limited to any theory, in some instances improved dynamic surface tension, such as a reduction in surface tension, can in some aspects aid in the foliar deposition of herbicides.

For example, a reduction in dynamic surface tension can aid in the deposition of herbicides in a composition, such as those dissolved in solution or in solid form, by dispersing droplets of herbicidal compositions when they come into contact with a surface of the plant, such as on the leaf, and influence the retention of herbicides on plant, such as on the leaf (e.g., foliar deposition), which can then be absorbed into the plant. Such absorption can help the active ingredient (such as an herbicide) reach various cellular sites where the active ingredient disrupts vital process or structure.

Thus, various compositions disclosed herein and various aspects of this disclosure, have improved properties beneficial to use of pesticidal compositions in various area, such as in agricultural use (e.g., such as controlling weeds in a field). FIG. 2 illustrates the dynamic surface tension of 1% dilutions of the compositions with different solvents as detailed in examples as a function of time.

Dynamic surface tension was measured using a Kruss BP-2 Bubble Pressure Tensiometer. During the test, high purity nitrogen gas bubbles are produced in the 1% dilution of each sample at an exactly defined bubble generation rate. The gas bubbles enter the liquid through a glass capillary of known diameter (0.938 mm). During this process the pressure passes through a maximum whose value is recorded by the instrument. Surface tension is then calculated from the maximum pressure during bubble formation, and reported as a function of bubble surface age, in ms, and bubble frequency. The measurements were made at ambient temperature.

For example, Table 1 below contains data for the dynamic surface tension for 1% dilution in 342 ppm water of the various emulsifiable concentrate formulations described above. The results of Table 1 below help to illustrate the differences in dynamic surface tension that—in some aspects—could be associated with the properties of various solvents of various aspects in this disclosure. As described above, improved dynamic surface retention of sprayed tank mixes may desired to improve foliar deposition of herbicides, including dissolved herbicides. Improved foliar deposition can be understood to include surface tension balance that allows wetting of the leaf surface and yet sufficiently high as to prevent run-off from the leaf.

TABLE 1
Dynamic Surface Tension - Dilutions of example compositions
to deliver 15 g tolpyralate per hectare assuming
100 liters total volume per hectare.

| | | Surface Tension [mN/m] | | |
|---|---|---|---|---|
| | | 100 | 150 | 200 |
| Example | Solvent | ms | ms | ms |
| Control 1 | Water (reference) | 76.26 | 75.81 | 75.81 |
| Example 1-1 | Benzyl Alcohol | 51.87 | 49.25 | 47.87 |
| Example 1-2 | Dowanol EPH | 49.25 | 48.50 | 46.03 |
| Example 1-3 | Acetophenone | 48.17 | 45.10 | 44.80 |
| Example 1-4 | Methyl Salicylate | 47.57 | 46.96 | 45.40 |
| Example 1-5 | Triethyl Citrate | 45.73 | 43.72 | 42.49 |
| Example 1-6 | Dowanol PM | 45.73 | 43.72 | 41.58 |
| Example 1-7 | Jeffsol AG 1705 (benzyl acetate) | 45.73 | 44.20 | 43.72 |
| Example 1-8 | Tetrahydrofurfuryl alcohol | 45.40 | 42.66 | 41.28 |
| | (THFA) | | | |
| Example 1-9 | Jeffsol AG 1555 (propylene | 45.40 | 42.49 | 41.13 |
| | carbonate) | | | |
| Example 1- | DMSO | 45.40 | 42.49 | 40.95 |
| 10 | | | | |
| Example 1- | Rhodiasolv RPDE | 45.25 | 42.81 | 41.43 |
| 11 | | | | |
| Example 1- | Purasolv EL (ethyl lactate) | 44.95 | 42.33 | 40.95 |
| 12 | | | | |
| Example 1- | Y-butyrolactone | 44.95 | 42.18 | 40.65 |
| 13 | | | | |
| Example 1- | Dowanol PMA | 44.65 | 41.88 | 40.65 |
| 14 | | | | |
| Example 1- | Estasol | 44.20 | 41.58 | 40.20 |
| 15 | | | | |
| Example 1- | Dowanol PGDA | 43.87 | 41.43 | 40.35 |
| 16 | | | | |
| Example 1- | Agnique AMD 3L | 43.87 | 41.13 | 39.90 |
| 17 | | | | |
| Example 1- | TamiSolve NxG | 43.72 | 41.28 | 40.05 |
| 18 | | | | |
| Example 1- | Armid FMPC | 43.42 | 40.80 | 39.74 |
| 19 | | | | |
| Example 1- | 4-Formylmorpholine | 43.42 | 40.65 | 39.42 |
| 20 | | | | |
| Example 1- | Solvall BDE-1 | 43.42 | 40.65 | 39.42 |
| 21 | | | | |

The following examples in Table 2 were prepared with the same corresponding formulations listed as above in Table 1, with the exception that the active was changed from tolpyralate to tembotrione. For example, Example 2-1 was prepared the same as Example 1-1, with the exception that the emulsifiable concentrate formulation was created with 15 g/L of tembotrione. About 1.58 wt % of tolpyralate tech (95% purity) was dissolved in about 48.42 wt % of benzyl alcohol, about 10 wt % of an adjuvant (such as Lutensol TDS 6), about 10 wt % of a mixture of emulsifiers (such as about 8 wt % of ANIQUE CSO-25, about 1 wt % of ATLAS G5000, and about 1 wt % of Aerosol OT-S), and about 30 wt % solvent naphtha (petroleum), heavy aromatic such as Aromatic 150 naphthalene depleted).

TABLE 2
Dynamic Surface Tension - Dilutions of example compositions
to deliver 15 g tembotrione per hectare assuming
100 liters total volume per hectare.

| | | Surface Tension [mN/m] | | |
|---|---|---|---|---|
| | | 100 | 150 | 200 |
| Example | Solvent | ms | ms | ms |
| Control 2 | Water (reference) | 71.77 | 71.83 | 72.21 |
| Example 2-2 | Dowanol EPH | 49.47 | 47.22 | 46.23 |
| Example 2-4 | Methyl Salicylate | 48.04 | 47.28 | 45.93 |
| Example 2-6 | Dowanol PM | 47.58 | 44.49 | 42.94 |
| Example 2-1 | Benzyl Alcohol | 47.32 | 44.83 | 44.33 |
| Example 2- | Purasolv EL (ethyl lactate) | 47.22 | 44.32 | 42.83 |
| 12 | | | | |
| Example 2- | Y-butyrolactone | 47.05 | 43.75 | 42.23 |
| 13 | | | | |
| Example 2- | Armid FMPC | 46.67 | 43.47 | 42.02 |
| 19 | | | | |
| Example 2- | 4-Formylmorpholine | 46.66 | 43.37 | 41.82 |
| 20 | | | | |
| Example 2- | DMSO | 46.44 | 43.22 | 40.65 |
| 10 | | | | |
| Example 2- | Agnique AMD 3L | 46.18 | 43.09 | 41.44 |
| 17 | | | | |
| Example 2- | Solvall BDE-1 | 46.09 | 42.87 | 41.37 |
| 21 | | | | |
| Example 2- | Dowanol PMA | 45.75 | 42.33 | 41.58 |
| 14 | | | | |
| Example 2-8 | Tetrahydrofurfuryl alcohol | 45.65 | 42.5 | 41.08 |
| | (THFA) | | | |
| Example 2- | Rhodiasolv RPDE | 45.62 | 43.02 | 42.25 |
| 11 | | | | |
| Example 2- | Dowanol PGDA | 45.38 | 42.96 | 41.77 |
| 16 | | | | |
| Example 2- | TamiSolve NxG | 45.29 | 42.66 | 41.44 |
| 18 | | | | |
| Example 2-3 | Acetophenone | 45.11 | 43.09 | 42.43 |
| Example 2-9 | Jeffsol AG 1555 (propylene | 44.93 | 41.87 | 40.31 |
| | carbonate) | | | |
| Example 2- | Estasol | 44.92 | 42.28 | 41.4 |
| 15 | | | | |
| Example 2-7 | Jeffsol AG 1705 (benzyl acetate) | 44.65 | 42.48 | 42.43 |
| Example 2-5 | Triethyl Citrate | 42.89 | 40.06 | 39.55 |

The following examples in Table 3 were prepared with the same corresponding formulations listed as above in Table 1, with the exception that the active was changed from tolpyralate to isoxaflutole. For example, Example 3-1 was prepared the same as Example 1-1, with the exception that the emulsifiable concentrate formulation was created with 15 g/L of isoxaflutole. About 1.58 wt % of isoxaflutole tech (95% purity) was dissolved in about 48.42 wt % of benzyl alcohol, about 10 wt % of an adjuvant (such as Lutensol TDS 6), about 10 wt % of a mixture of emulsifiers (such as about 8 wt % of ANIQUE CSO-25, about 1 wt % of ATLAS G5000, and about 1 wt % of Aerosol OT-S), and about 30 wt % solvent naphtha (petroleum), heavy aromatic (such as Aromatic 150 naphthalene depleted).

TABLE 3
Dynamic Surface Tension - Dilutions of example compositions
to deliver 15 g isoxaflutole per hectare assuming
100 liters total volume per hectare.

| | | Surface Tension [mN/m] | | |
|---|---|---|---|---|
| | | 100 | 150 | 200 |
| Example | Solvent | ms | ms | ms |
| Control 3 | Water (reference) | 71.77 | 71.83 | 72.21 |
| Example 3-4 | Methyl Salicylate | 51.13 | 46.74 | 46.92 |
| Example 3-2 | Dowanol EPH | 49.13 | 46.89 | 45.7 |
| Example 3-1 | Benzyl Alcohol | 47.42 | 45.19 | 43.84 |
| Example 3- | y-butyrolactone | 47.28 | 44.09 | 42.63 |
| 13 | | | | |
| Example 3-8 | Tetrahydrofurfuryl alcohol | 47.18 | 44.08 | 42.53 |
| | (THFA) | | | |
| Example 3- | DMSO | 46.87 | 43.83 | 42.12 |
| 10 | | | | |
| Example 3- | Armid FMPC | 46.84 | 43.52 | 41.92 |
| 19 | | | | |
| Example 3- | Agnique AMD 3L | 46.81 | 43.53 | 41.99 |
| 17 | | | | |
| Example 3- | 4-Formylmorpholine | 46.81 | 43.62 | 41.9 |
| 20 | | | | |
| Example 3-3 | Acetophenone | 46.72 | 44.22 | 43.58 |

3-

| | | | | |
|---|---|---|---|---|
| Example 3- | Purasolv EL (ethyl lactate) | 46.59 | 43.43 | 41.97 |
| 12 | | | | |
| Example 3-6 | Dowanol PM | 46.2 | 42.97 | 41.41 |
| Example 3-9 | Jeffsol AG 1555 (propylene | 46.18 | 43.4 | 41.94 |
| | carbonate) | | | |
| Example 3- | Dowanol PMA | 46.16 | 43.2 | 42.46 |
| 14 | | | | |
| Example 3- | Solvall BDE-1 | 46.04 | 42.73 | 41.55 |
| 21 | | | | |
| Example 3- | Rhodiasolv RPDE | 45.75 | 42.79 | 41.69 |
| 11 | | | | |
| Example 3- | Estasol | 44.98 | 42.74 | 41.39 |
| 15 | | | | |
| Example 3- | Dowanol PGDA | 44.78 | 43.19 | 42.3 |
| 16 | | | | |
| Example 3- | TamiSolve NxG | 44.77 | 42.28 | 41 |
| 18 | | | | |
| Example 3-7 | Jeffsol AG 1705 (benzyl acetate) | 44.28 | 43.54 | 41.47 |
| Example 3-5 | Triethyl Citrate | 44.13 | 42.07 | 40.42 |

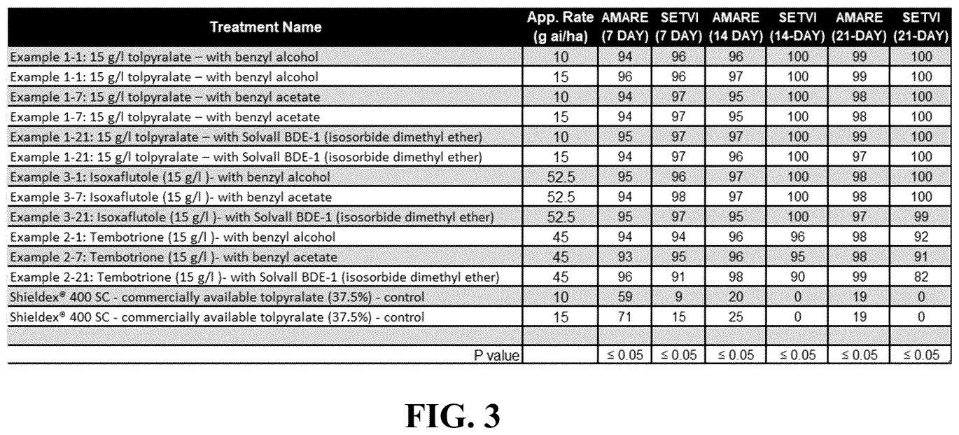

FIG. 3 contains a table illustrating exemplary herbicidal compositions and their effect on AMARE, redroot pigweed (Amaranthus retroflexus), and SETVI, green foxtail (Setaria viridis). FIG. 3 contains the response of the weeds 7 days, 14 days, and 21 days after application of the exemplary compounds. SHIELDEX® 400 SC, a commercially available tolpyralate composition (35.7%) from SummitAgro USA LLC, a company based in Durham, North Carolina, was used as a control for comparison purposes. As can been seen, various herbicidal compositions disclosed herein can improve the efficacy of the HPPD inhibitor by about 5%, 10%, 15%, 20% 25%, 30%, 35%, 40%, 45%, 50%, 55%, 60%, 65%, 70%, 75%, 80%, 85%, 90%, 95% or more compared to the HPPD inhibitor alone.

While this disclosure has been described with various aspects, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an aspect, B alone may be present in an aspect, C alone may be present in an aspect, or that any combination of the elements A, B or C may be present in a single aspect; for example, A and B, A and C, B and C, or A and B and C.

In the detailed description herein, references to “one aspect,” “an aspect,” “an example aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art with the benefit of the present disclosure to affect such feature, structure, or characteristic in connection with other aspects whether or not explicitly described. After reading the description, it will be apparent to one skilled in the relevant art(s) how to implement the disclosure in alternative aspects.

1. A composition comprising:
a hydroxyphenyl pyruvate dioxygenase (HPPD) inhibitor; and
a solvent selected from the group consisting of polar solvents, aprotic solvents, aromatic solvents, and carboxylic esters, wherein the HPPD inhibitor is dissolved in the solvent.

2. The composition according to claim 1, further comprising a safener.

3. The composition according to claim 2, wherein the safener is an azole safener.

4. The composition according to claim 3, wherein the azole safener is selected from the group consisting of fenchlorazole, flurazole, furilazole, isoxadifen, mefenpyr, an agriculturally acceptable salt or ester thereof, and mixtures thereof.

5. The composition according to claim 4, wherein the safener is selected from the group consisting of benoxacor, diamuron, cumyluron, dimepiperate, dymron, cloquintocet, cyprosulfamide, cyometrinil, dichlormid, fenclorim, fluxofenim, MG 191, AD-67, napthalic anhydride, oxabetrinil, dietholate, metcamifen, and mixtures thereof.

6. The composition according to claim 5, wherein the safener is cloquintocet-mexyl or cloquintocet-acid.

7. (canceled)

8. The composition according to claim 4, wherein the safener is mefenpyr-diethyl.

9. The composition according to claim 1, wherein the composition is an emulsion concentrate, a micro-emulsion, or a suspo-emulsion.

10. The composition claim 1, further comprising a nitrile herbicide.

11. The composition according to claim 10, wherein the (ae) weight ratio of the HPPD inhibitor to the nitrile herbicide is between about 200:1 to about 1:200.

12. (canceled)

13. The composition according to claim 10, wherein the nitrile herbicide is bromoxynil or an agriculturally acceptable salt or ester thereof.

14. The composition according to claim 13, wherein the nitrile herbicide is bromoxynil-octanoate.

15. The composition according to claim 1, wherein the HPPD inhibitor is tolpyralate or an agriculturally acceptable salt or ester thereof.

16. The composition according to claim 1, wherein the solvent is selected from the group consisting of polar aprotic solvents, aromatic alcohols, aromatic esters, aromatic ketones, cyclic carboxylic esters, alkyl carbonate, lactones, lactates, ketones, esters, and alcohols.

17. The composition according to claim 1, wherein the solvent is selected from the group consisting of benzyl alcohol, propylene glycol mono methyl ether acetate, benzyl acetate, acetophenone, y-butyrolactone, propylene carbonate, dibasic esters, dimethyl sulfoxide, and mixtures thereof.

18. The composition according to claim 1, wherein the solvent is selected from the group consisting of propylene glycol diacetate, dimethyl succinate, dimethyl adipate, dimethyl succinate, dimethyl adipate, dimethyl glutarate, 4-formylmorpholine, N—N-dimethyl lactamide, isosorbide dimethyl ether, ethyl lactate, methoxy propanol and mixtures thereof.

19. The composition according to claim 1, wherein the solvent is selected from the group consisting of tetrahydrofurfuryl alcohol, dipropylene glycol mono methyl ether, methyl salicylate, a high-boiling dipolar aprotic solvent, tri-ethyl citrate, and mixtures thereof.

20. The composition according to claim 10, further comprising a second solvent, wherein the nitrile herbicide is dissolved in the second solvent.

21. The composition according to claim 1, wherein the solvent improves an efficacy of the HPPD inhibitor against an undesirable plant by more than about 10% when compared to application of the HPPD inhibitor alone.

22. The composition according to claim 21, wherein the solvent improves an efficacy of the HPPD inhibitor against an undesirable plant by more than about 50% when compared to application of the HPPD inhibitor alone.

23. The composition according to claim 21, wherein the undesirable plant is redroot pigweed (Amaranthus retroflexus) or green foxtail (Setaria viridis).
